(19) United States
(12) Patent Application Publication
(10) Pub. No.: US 2024/0012388 A1
(43) Pub. Date: Jan. 11, 2024

(54) SYSTEM AND APPARATUS FOR OPTIMIZING THE ENERGY CONSUMPTION OF MANUFACTURING EQUIPMENT

(71) Applicant: Full Speed Automation, Inc., Los Gatos, CA (US)

(72) Inventor: Luc Leroy, Los Gatos, CA (US)

(21) Appl. No.: 18/252,645

(22) PCT Filed: Oct. 21, 2021
(86) PCT No.: PCT/US21/55966

§ 371 Date: May 11, 2023

Related U.S. Application Data
(60) Provisional application No. 63/094,869, filed on Oct. 21, 2020.

(51) Int. Cl. G05B 19/4155

(52) U.S. Cl. CPC G05B 19/4155; G05B 2219/32021

(57) ABSTRACT

An energy management system or plugin thereto includes a graphical user interface that displays visual elements corresponding to at least one manufacturing component and an energy management module instantiated in the graphical user interface. The energy management module is enabled to receive and display energy consumption status information from the manufacturing component and can control and modify the energy consumption of the manufacturing component by instructions sent from the energy management system to the component. The instructions can comprise a throttle instruction, an orchestrate instruction, or a disabled instruction which can be configured as predetermined presets corresponding to a desired energy protocol. The energy management module can also be used to group or sequence the components to distribute energy consumption to avoid exceeding the energy capacity of the manufacturing setting.

### CROSS REFERENCE TO RELATED APPLICATIONS

This application is the National phase under 35 U.S.C. § 371 of International Application No. PCT/US2021/58903, filed Nov. 11, 2021, which claims priority to U.S. Provisional Application No. 63/113,642 filed on Nov. 13, 2020. The entire contents of these patent applications are hereby incorporated by reference herein.

### TECHNICAL FIELD

The present invention generally relates to automation controls technology and specifically to a system for managing the energy consumption of manufacturing equipment used in an automation setting.

### BACKGROUND ART

Since the introduction of programmable logic controllers in the field of automation controls, the capabilities of computers have greatly improved, with faster microprocessors allowing greater compute, larger and faster memory enabling the execution of larger and more complex programs that manipulate larger amounts of data. Network interconnectivity has also dramatically improved and components that used to be connected to programmable logic controllers (PLC), such as the early Allen Bradley PLC, via direct wires driving analog signals are now often communicating with the logic controller over Ethernet or similar network protocols. Over time, programmable logic computers have grown into computers to such an extent that nowadays popular programmable logic controllers use electronics similar to personal computers such as a computer system based on an Intel processor and are capable of running an operating system designed for personal computers, professional workstations and servers such as Microsoft Windows, different distributions of Linux or similar operating systems. Popular examples of such modern programmable logic controllers are the Siemens SIMATIC or the Beckhoff CX families of controllers.

Requirements and practices in the field of manufacturing have similarly evolved. Modeling tools have allowed the complexity of equipment, manufacturing lines and factories to grow significantly. It is not uncommon to observe hundreds of devices—from basic sensors to sophisticated industrial robots, connected to a single controller. The frequency and amount of data transferred across controllers and components has followed the same trend. Hundreds of megabytes of data transferred per second with latencies measured in milliseconds and sometimes microseconds for specialized controllers is a common trade. Data related to material flow, supply chain, product quality, human resources and a myriad of other fields are now part of the data manipulated by controllers and manufacturing execution systems.

Human-machine interfaces have historically been discrete from and connected to the programmable logic controller. More recently, following the increasing connectivity in factories and the growing usage of servers, these interfaces can be connected to a server which receives information from the programmable logic controller directly or indirectly, and the human-machine interface principally comprises a user interface on a computer display.

It is also common to find a manufacturing execution system hosted on a server possibly outside of the manufacturing premise and sometimes on a distributed system. The manufacturing execution system is responsible for collecting cycle data from programmable logic controllers and sending data to these controllers in order to orchestrate manufacturing and coordinate material flow and other systems.

Other devices and systems such as, for example, smart cameras used for quality control or presence sensors are conventionally discrete from, but directly connected to, a programmable logic controller. Such increase in the number of connected devices and systems in factories has led to a growing traffic over the network infrastructure, and more complexity to manage connections. One critical aspect of managing these connections is to ensure that the network capacities in the factory are aligned with the bandwidth requirements to transfer data in an adequate timely manner, so that the numerous devices and components can act under the time allowed. This is particularly true for safety and shutoff devices and components, which must act and react in short periods of time varying from microseconds to a few milliseconds. The type of connections—wherever they should be analog or digital, can be selected appropriately to optimize the performance of communications between components.

Modern programmable logic controllers typically support multiple types of connections to facilitate the fulfilling of these connectivity requirements. For instance, multiple analog ports are available as communication extensions that can be connected to the core unit of the controller. The core controller uses a proprietary protocol such as EthernetIP, Profinet or EtherCAT developed by Allen-Bradley, Siemens and Beckhoff, respectively, to connect with most automation devices such as actuators, motors, sensors and robots. Also, since the early 2000's most programmable logic controllers have been equipped with at least one Ethernet port which allows them to communicate with the enterprise's network.

Determinism is a key requirement in the selection of the language used to program the controllers that interface with multiple devices critical to the execution and safety of manufacturing equipment. High-level interpreted languages such as Python and javascript are appealing to quickly develop complex programs. However, such languages cannot offer the assurance that code execution will consistently be ensured with predictable timing. They may be suitable for the development of user interfaces, part of the human-machine interfaces for a manufacturing automation system but should not be used to develop the logic that will orchestrate and/or interface with equipment and automation devices.

Telemetry is another key requirement for automation controls. To monitor the status of processes and equipment, data originated from devices, processes and systems will ideally be captured and made available to allow for the analysis of such data. Benefits of making such data available include the ability to troubleshoot and diagnose as well as to better understand the behavior of equipment and systems to increase efficiency, quality and minimize failures.

Recently, energy consumption has become a key criterion when it comes to handling equipment, as well as producing and transporting goods. The Cost of electricity varies over different hours of the day and night, and sustainable sources of energy such as solar panels create inconsistencies regarding the availability of energy at a given time. Also, imminent regulations led by Europe and soon followed by some countries in Asia will require an increasingly precise traceability of energy used to produce goods in order to evaluate the carbon footprint of their manufacturing or production.

Accordingly, to improve the traceability of energy used to produce, and to optimize the energy consumption and ensure it remains below specific consumption targets, the present invention provides a system to track and handle energy consumption for manufacturing equipment.

### DESCRIPTION OF THE INVENTION

In some embodiments, the present invention comprises a energy management system including a graphical user interface that is used via one or more user input devices such as a mouse, a keyboard, a voice input device, a touch input device for receiving a gesture from a user, a motion input device for detecting non-touch gestures and other motions by a user, and the like. Output devices such as a graphical display, speakers, printer, haptic devices, and other types of output devices may also be included in the user interface.

The user interface is executed by an embedded computer that possesses one or multiple connectors to control and read data from manufacturing components such as motors, sensors, stack lights, furnaces, scanners, and like equipment that are used to manufacture products. In some embodiments, the graphical user interface is executed on Windows and has been developed for Microsoft Visual Studio, using the C #(C-Sharp) language. However, it is appreciated and understood that the graphical user interface described in the current invention can be adapted to use other languages such as C++, Visual Basic, and the like and can also be modified to work on other operating systems such as Linux. In some embodiments, the present invention comprises an extension or addition (or set of extensions or additions, sometimes referred to as plugins) to an energy management system or, in some embodiments, may comprise a standalone energy management system, in each case exposing a graphical user interface.

In some embodiments, the present invention orchestrates the actions of a plurality of manufacturing components and can receive information from these components regarding their energy consumption. For instance, an electric motor used in a factory is typically controlled by a motor drive that receives as input the target rotation speed and direction sometimes referred to as the set point and will send as an output the actual current speed of the motor as well as the electric current used by the physical motor. Accordingly, the energy consumption of the motor can be determined as a factor of the current that it draws.

Ideally, the power consumption of each component in a factory, line, subline or shop is known, and the consumption of each individual asset is multiple times, or within a predetermined safety factor, below the total amount of energy available. In such a case the present invention handles the orchestration of equipment to keep the overall consumption below the desired consumption level. In some embodiments, the present invention offers the possibility to defer operations in a facility to keep the consumption below the desired level. This can reduce the overall throughput of operations but guarantees that operations will remain running. For instance, furnaces, conveyors, and robots could be all operated at the time to accelerate operation and increase the throughput of a production facility. However, this may result in consuming energy exceeding the amount of energy available, whether it be peak power (or instantaneous power) or overall energy consumption over a given period. To keep the consumption below a predetermined or known instantaneous power consumption, or to maintain the overall energy consumption below a predetermined or known threshold, the present invention is configured to coordinate operations of the manufacturing equipment in groups or in sequence to preserve headroom in energy consumption to maintain safety and account for any potential peaks or unusual or unpredictable power spikes or surges.

Often the maximum power consumption of equipment is undocumented, but instantaneous power requirements are known. Thus, to determine power consumption and power availability, the known instantaneous power requirement is deducted from the amount of electrical current drawn through the power supply or controller of a component, the voltage being typically known and stable. The simple product of the voltage (in Volts) by the current (in Amperes) gives the instantaneous power (in Watts). Accordingly, the present invention works in closed loop control mode: the power allowed to be drawn by component is controlled either by distributing the power amongst components (grouping or sequencing), by throttling the power used by one or more components (for instance by limiting the current and speed allowed for an electric motor) or by a combination of both throttling and distributing the power.

A benefit of monitoring and recording the instant energy used by each or a group of manufacturing components in the energy management system, is that it generates repetitive patterns of signals that characterize the behavior of the equipment in each context or running mode. This characterization allows for a numerical modeling of the process and equipment and therefore enables identification of the pattern of a correct operation cycle for a given component, combination of components, or the entire manufacturing setting. This enables the counting of production cycles, the determination of the cycle time, counting cycles and allows for the detection of deviations from the most repetitive pattern—referred to as the baseline. Material deviation from the baseline suggests a potential failure that is worth reporting as an area of attention to anticipate some special service or maintenance to address the cause of the measured numerical deviation. This form of predictive maintenance has significant advantages over the traditional preventive maintenance cycle which requires the execution of frequent service procedures to keep the equipment in good standing, at the cost of equipment shutdowns which result in significant production losses.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

FIG. 1 is snippet of a graphical user comprising an information message panel enabled by the present invention.

FIG. 2 is a snippet of a graphical user interface comprising a property panel enabled by the present invention.

FIG. 3 is another snippet of a graphical user interface comprising an energy management module enabled by the present invention.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### BEST MODE FOR CARRYING OUT THE INVENTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

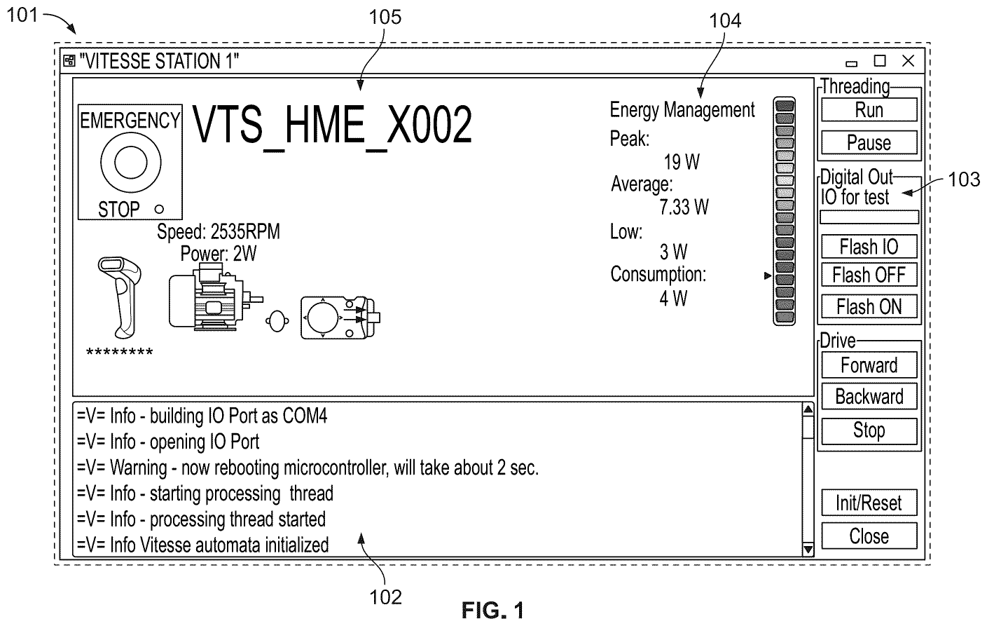

FIG. 1 depicts the typical components and interfaces of a manufacturing setting shown as visual elements within an energy management system comprising a graphical user interface in accordance with the present invention. In some embodiments, the user interface (101) comprises an informative message panel (102) that displays messages related to the execution of the process for the manufacturing setting, debugging tools (103) that allow the user to manipulate the components connected to the energy management system and a layout panel (105) which contains multiple components representing physical and logical functions and the components of the manufacturing setting. An energy management module (104) is integrated into the layout to enable users to view and determine the different states of energy consumption in the manufacturing setting. Based on settings, the energy management module (104) can control the amount of power consumed by the component interfaced with the controlling computer executing the energy management system.

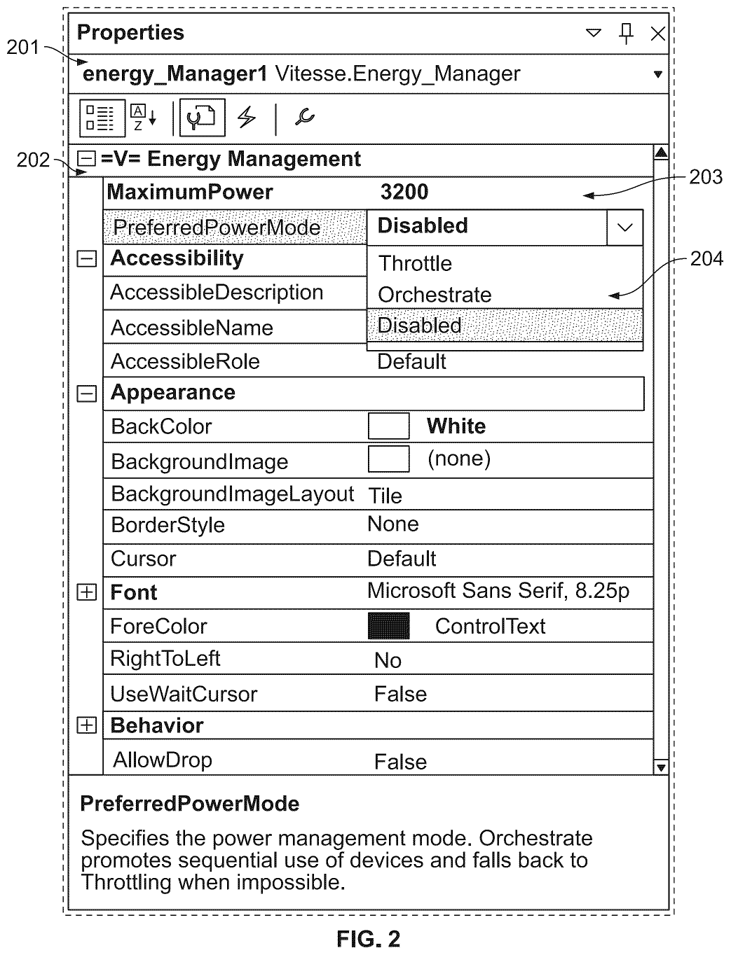

FIG. 2 depicts an embodiment of the property panel of the energy management system. The default property panel for any component (201) in the energy management system is augmented with a property section (202) specific to the component. The maximum power available (103) for the manufacturing setting is highlighted and, in this example, is limited to 3200 Watts. The energy consumption management preset ‘PreferredPowerMode’ is currently disabled, while other presets (104) are available: Throttle and Orchestrate. Accordingly, the property panel permits the user to access one or more presets which reflect or corresponding to a predetermined energy management protocol to be sent to one or more of the components.

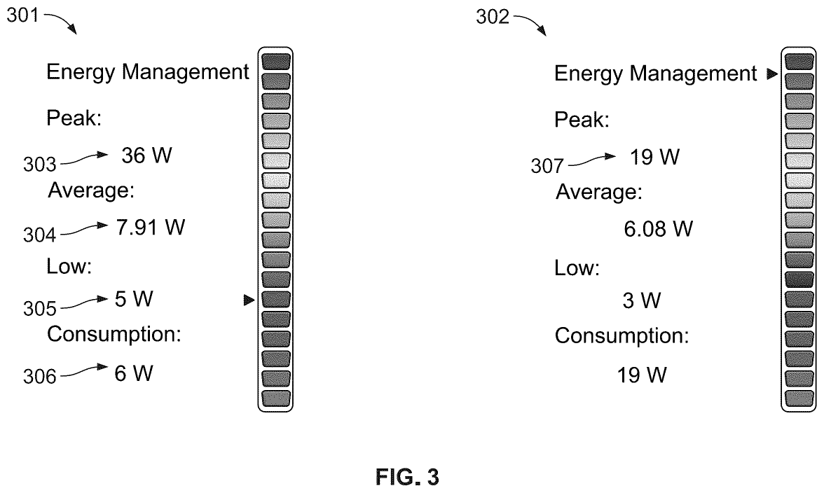

FIG. 3 is a screenshot of an energy management module instantiated in the user interface enabled by the energy management system. Here, the manufacturing setting controls a 35-Watt electric motor driving a small conveyor and a stack light. The left-hand module (301) shows a monitoring mode which reflects a peak power consumption (303) of 36 W and an average power consumption over a cycle (304) of 7.91 Watts. The righthand module (302) shows settings of a predetermined limit not to consume more than 20 Watts by limiting the peak power consumption (307) while the average power consumption over a cycle was just over 6 Watts.

The described energy management system (or extension, addition, or plugin thereto) can be implemented within a single processing device but can also be distributed across multiple processing devices or sub-systems that cooperate in executing program instructions. Examples of processing system include general purpose central processing units, application specific processors, and logic devices, as well as any other type of processing device, combinations of processing devices, or variations thereof. Storage system can comprise any storage media readable by processing system, and capable of storing software. Storage system can include volatile and nonvolatile, removable and non-removable media implemented in any method or technology for storage of information, such as computer readable instructions, data structures, program modules, or other data. Storage system can be implemented as a single storage device but may also be implemented across multiple storage devices or sub-systems. Storage system can comprise additional elements, such as a controller, capable of communicating with the system. Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only the claims and equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. An energy management system, comprising:
graphical user interface displaying one or more visual elements corresponding to at least one manufacturing component; and
an energy management module instantiated in the graphical user interface and enabled to receive and display energy consumption status information from the manufacturing component; and
the energy management module enabled to control and modify the energy consumption of the manufacturing component.

2. The energy management system of claim 1, wherein the graphical user interface enables the addition, removal, or modification of the visual elements corresponding to the manufacturing component.

3. The energy management system of claim 1, wherein the energy consumption of the manufacturing component is controlled and modified by instructions sent from the energy management system to the component.

4. The energy management system of claim 3, wherein the instructions comprise a throttle instruction, an orchestrate instruction, or a disabled instruction.

5. The energy management system of claim 3, wherein the instructions comprise one or more presets comprising a predetermined energy management protocol.

6. A plugin for an energy management system, comprising:
graphical user interface displaying one or more visual elements corresponding to at least one manufacturing component;
an energy management module instantiated in the graphical user interface and enabled to receive and display energy consumption status information from the manufacturing component; and
the energy management module enabled to control and modify the energy consumption of the manufacturing component.

7. The plugin of claim 6, wherein the graphical user interface enables the addition, removal, or modification of the visual elements corresponding to the automation controls component.

8. The plugin of claim 6, wherein the energy consumption of the manufacturing component is controlled and modified by instructions sent from the energy management system to the component.

9. The plugin of claim 8, wherein the instructions comprise a throttle instruction, an orchestrate instruction, or a disabled instruction.

10. The plugin of claim 8, wherein the instructions comprise one or more presets comprising a predetermined energy management protocol.

11. A method of controlling the energy consumption of a manufacturing component, comprising:
a. providing an energy management system comprising: (i) a graphical user interface and (ii) an energy management module instantiated in the graphical user interface;
b. adding, through the graphical user interface, one or more visual elements corresponding to at least one manufacturing component;
c. receiving, from the manufacturing component, data corresponding to the energy consumption of the manufacturing component;
d. displaying, on the graphical user interface, the data corresponding to the energy consumption of the manufacturing component; and
e. controlling and modifying, via the energy management system, the energy consumption of the manufacturing component by transmitting instructions thereto.

12. The method of claim 11, wherein the instructions comprise a throttle instruction, an orchestrate instruction, or a disabled instruction.

13. The method of claim 12, wherein the instructions comprise one or more presets comprising a predetermined energy management protocol.
